(19) United States
(12) Patent Application Publication
(10) Pub. No.: US 2019/0222090 A1
(43) Pub. Date: Jul. 18, 2019

(54) Cooling System for an Electric Machine

(71) Applicant: Continental Automotive GmbH, Hannover (DE)

(72) Inventors: Jin-Kang Li, Shanghai (CN); Holger Fröhlich, Berlin (DE); Wolfgang Halbmeyer, Berlin (DE); Matthias Uecker, Berlin (DE); Yakup Guensayan, Berlin (DE)

(73) Assignee: Continental Automotive GmbH, Hannover (DE)

(21) Appl. No.: 16/306,355

(22) PCT Filed: May 4, 2017
(86) PCT No.: PCT/EP2017/060690

§ 371 Date: Nov. 30, 2018

(30) Foreign Application Priority Data
Jun. 3, 2016 (DE) 10 2016 209 752.0

(51) Int. Cl. H02K 5/20; H02K 9/19

(52) U.S. Cl. CPC H02K 5/20; H02K 9/19

(57) ABSTRACT

Various embodiments include an installation part for a housing of an electric machine, the installation part comprising: a contour configured to mount within the housing; and a feature defining a section of a cooling duct when the installation part is joined together with the housing.

### CROSS-REFERENCE TO RELATED APPLICATIONS

This application is a U.S. National Stage Application of International Application No. PCT/EP2017/060690 filed May 4, 2017, which designates the United States of America, and claims priority to DE Application No. 10 2016 209 752.0 filed Jun. 3, 2016, the contents of which are hereby incorporated by reference in their entirety.

### TECHNICAL FIELD

The present disclosure relates to electric machines. Various embodiments may include a system for cooling an electric machine, such as an electric motor or generator.

### BACKGROUND

Drive devices, in particular hybrid drive devices, are used to drive motor vehicles. A hybrid drive device typically has an internal combustion engine and an electric machine. The electric machine functions as a motor and generator and has a shaft with a rotor arranged on the shaft plus a stator. The stator and the rotor are arranged within a housing of the electric machine. Waste heat is produced in the electric machine, in particular in the stator and/or rotor thereof, so it is necessary to cool the electric machine. For this purpose, a cooling duct for conducting through a cooling fluid, for example liquid coolant or air, for cooling the electric machine, is typically formed in the housing. After the cooling fluid has been introduced into the cooling duct, the cooling fluid absorbs heat.

A typical housing of an electric machine with an integrated cooling duct is often formed, either in one piece using the permanent mold casting method, or in two pieces with an inner housing and an outer housing. In the last-mentioned method, the inner housing is fitted into the outer housing and as a result the housing is produced with the cooling duct. During the manufacture of the electric machine, it is generally desired that the electric machine requires little installation space. From this it is necessary for an outer diameter or circumference of the housing—in the case of a single-piece design and in the case of a two-piece design—to be as small as possible. As result it is possible to achieve a saving in terms of installation space and furthermore to reduce the amount of material for producing the housing and/or the electric machine.

### SUMMARY

The teachings of the present disclosure may be embodied in systems for cooling an electric machine, by means of which cost-effective cooling of an electric machine, in particular of the winding heads thereof, is made possible in a way which is optimized in terms of installation space. For example, some embodiments include an installation part (16, 18, 26, 28) for a housing (8) of an electric machine (1), wherein the installation part (16, 18, 26, 28) is configured in such a way that in the state in which it is installed in the housing (8) it forms a section (13, 14, 27, 29) of a cooling duct (11) together with the housing (8).

In some embodiments, the section (13, 14, 27, 29) of the cooling duct (11) is located in the region of a winding head (6, 7) of the electric machine (1).

In some embodiments, the installation part (16, 18, 26, 28) is a deep-drawn, sheet-metal part.

As another example, some embodiments include a housing (8) for an electric machine (1), wherein the housing (8) forms a section (13, 14, 27, 29) of a cooling duct (11) together with an installation part (16, 18, 26, 28) as described above.

In some embodiments, the housing (8) has a depression or drilled hole (17, 19, 23, 30) in the region of the section (13, 14, 27, 29) of the cooling duct (11).

In some embodiments, the thickness of the housing (8) is greater in the region of the section (13, 14, 27, 29) of the cooling duct (11) than the thickness of the installation part (16, 18, 26, 28).

In some embodiments, the axial extent of the installation part (16, 18, 26, 28) is less than 30% of the maximum axial extent of the housing (8).

In some embodiments, the installation part (16, 18, 26, 28) is connected in a materially joined fashion to the housing (8).

In some embodiments, the installation part (16, 18, 26, 28) is connected to the housing (8) in a materially joined fashion by means of a bonded connection, and in that pockets or grooves (34) for adhesive of the bonded connection are formed between the installation part (16, 18, 26, 28) and the housing (8).

As another example, some embodiments include an electric machine (1) comprising a housing (8) as described above.

As another example, some embodiments include a method for producing an electric machine (1) comprising: making available an installation part (16, 18, 26, 28) as described above and a housing (8) with an inner contour (15), and attaching the installation part (16, 18, 26, 28) to the housing (8), with the result that the inner contour (15) of the housing (8) and the installation part (16, 18, 26, 28) form a section (13, 14, 27, 29) of a cooling duct (11) of the electric machine (1).

### BRIEF DESCRIPTION OF THE DRAWINGS

Exemplary embodiments of the teachings herein are discussed in more detail below on the basis of the schematic drawing, in which:

FIG. 1 shows a diagram of a half-section through an electric machine with a housing and two installation parts in the form of cooling duct covers in the region of the stator winding heads, incorporating teachings of the present disclosure;

FIG. 2 shows a diagram of a half-section through a further electric machine with a housing and an installation part which is embodied as an elongated cooling duct cover, incorporating teachings of the present disclosure;

FIG. 3 shows a sectional illustration of a further electric machine with a housing and an installation part which is embodied as a cooling duct cover and has the purpose of cooling the winding head, incorporating teachings of the present disclosure;

FIG. 4 shows an enlarged illustration of a detail of the installation part according to FIG. 3;

FIG. 5 shows a perspective view of an installation part for the electric machine according to FIG. 3; and

FIG. 6 shows a perspective view of the installation part according to FIG. 5.

### DETAILED DESCRIPTION

In some embodiments, an installation part for a housing of an electric machine is made available. The installation part is configured in such a way that in the state in which it is installed in the housing it forms a section of a cooling duct together with the housing. The cooling duct makes it possible to conduct heat away from the active parts of the electric machine partially and punctually. In particular, what are referred to as hotspots of the electric machine can be cooled partially and in a targeted fashion.

In some embodiments, the section of the cooling duct may be located in the region of a winding head of the electric machine. It is therefore possible to effectively conduct away waste heat which is produced in the region of the winding head as a particular hotspot.

The installation part may comprise a deep-drawn, sheet-metal part. The installation part or the cooling duct cover can therefore be produced with a small thickness from a piece of sheet metal, in particular from steel or aluminum, by deep drawing. The thickness of the installation part can be, in particular, between 1 mm and 3 mm.

In some embodiments, a housing for an electric machine is made available, in particular an outer housing with an inner contour, wherein the housing forms at least one section of a cooling duct together with an installation part as described above. The cooling duct section may be formed between the inner contour of the housing and the installation part. By mounting the installation part in the housing, particular in the outer housing, it is possible to form at least one cooling duct in a fashion which is media-tight with respect to the environment. A cooling duct which is formed along the inner contour of the outer housing makes a particularly small installation space possible for the housing of the electric machine, as result of which the electric machine and/or the housing thereof can be produced very economically in comparison with the prior art (in particular a permanent mold-cast housing or two-piece housing). The housing can be produced, in particular, using an aluminum die-casting method.

In some embodiments, the electric machine comprises an inlet opening, in particular embodied as an inlet connector, for conducting a cooling fluid into the at least one cooling duct section. The electric machine can likewise comprise an outlet opening, in particular embodied as an outlet connector, for conducting the cooling fluid out of the at least one cooling duct section.

In some embodiments, the cooling duct section which is formed by the installation part and the housing can also form a radial cooling duct section of a cooling system within the electric machine. The radial cooling duct section makes circulating cooling possible, in particular in the region of the winding head of the stator of the electric machine. In this context, gap fillers can be used for better conduction of heat. Furthermore, indirect cooling, e.g. by means of turbulent air circulation, which can be generated by rotation of a rotor of the electric machine, can be used. The radial cooling duct section can also be connected to an axial drilled hole within the housing in order to distribute coolant.

In some embodiments, the cooling duct section which is formed by the installation parts and the housing relies on a particularly simple design of the housing and installation part and ensures optimum cooling, in particular in the winding head region of the electric machine, as result of which a higher power yield can be achieved. In some embodiments, the housing has a depression, a drilled hole or an inner contour in the region of the cooling duct section. The depression or inner contour can be, in particular, a duct-like depression which runs around the circumference of the housing or the inner base of the housing and is designed to form the at least one cooling duct section.

In some embodiments, the thickness of the housing is greater in the region of the cooling duct section than the thickness of the installation part. In particular, the maximum thickness of the housing (including the webs for forming the cooling duct section) can be greater, in particular by an order of magnitude, than the thickness of the installation part or of the cooling duct cover. In some embodiments, the axial extent of the installation part is less than 30%, 20%, 10% or 5% of the maximum axial extent of the housing.

The housing and the installation part or the cooling duct cover may be connected to one another in a materially joined fashion. A materially joined connection which is necessary for this can be ensured, for example, by means of a bonded connection. Furthermore, to promote a corresponding bonding process (curing process) it is also possible to provide a clip connection between the housing and the installation part or the cooling duct cover. In so far as the installation part is connected in a materially joined fashion to the housing by means of an adhesive, there may be pockets or grooves for adhesive of the bonded connection to be formed between the installation part and the housing.

In some embodiments, the installation part is attached to the housing in a fluid-tight fashion in an axial end region of the housing by means of a sealing ring. In particular, the installation part can be connected in a materially joined fashion to the housing by means of an O ring. In this context, according to a further embodiment the housing can have at least one annular groove in which a corresponding sealing ring is arranged.

In some embodiments, an electric machine is made available which comprises a housing according to the invention as described above. In some embodiments, a method for producing an electric machine or a drive device is made available. The method comprises making available an installation part as described above and a housing with an inner contour. Furthermore, the installation part is attached to or in the housing, with the result that the inner contour of the housing and the installation part form a section of a cooling duct of the electric machine.

The installation part and the housing can be produced and made available separately from one another. The installation part can be, in particular, a deep-drawn, sheet-metal part. The housing can be produced, in particular, using a die-casting method. The inner contour of the housing can comprise, in particular, a duct-like depression in order to form the at least one cooling duct section. In addition, by means of mechanical processing, e.g. drilling, within the housing it is possible to produce at least one axial drilled hole for transporting and distributing coolant.

At the beginning or before the actual mounting of the housing and installation part, it is also possible to introduce a supply of adhesive into pockets or grooves which are provided for that purpose and which can be located between the installation part and the housing. By installing or introducing the installation part into the housing, at least one cooling duct, which can be configured, in particular, in a media-tight fashion, is formed between the housing and the installation part. The connection between the installation part and the housing is preferably materially joined. In order to promote the process of bonding of the installation part into the housing, a clip connection can be provided between the housing and the installation part.

As a result of the fact that the at least one cooling duct section is not produced in one working step, such as for example in the permanent mold-casting method known from the prior art, relatively cost-effective manufacturing methods are possible, in particular with respect to series manufacture. Therefore, in particular the housing can be produced using a die-casting method and the installation part using a deep-drawing method or impact extrusion method. As a result of the fact that the at least one cooling duct section can be produced during the mounting of the installation part in the housing, a particularly simple design with low manufacturing costs of the electric machine is possible. The electric machine can furthermore comprise in a known fashion, in particular, a stator with a stator laminated core, a rotor with a rotor laminated core and a rotor shaft, wherein coil windings with stator winding heads which protrude in the axial direction of the electric machine are introduced into the stator laminated core.

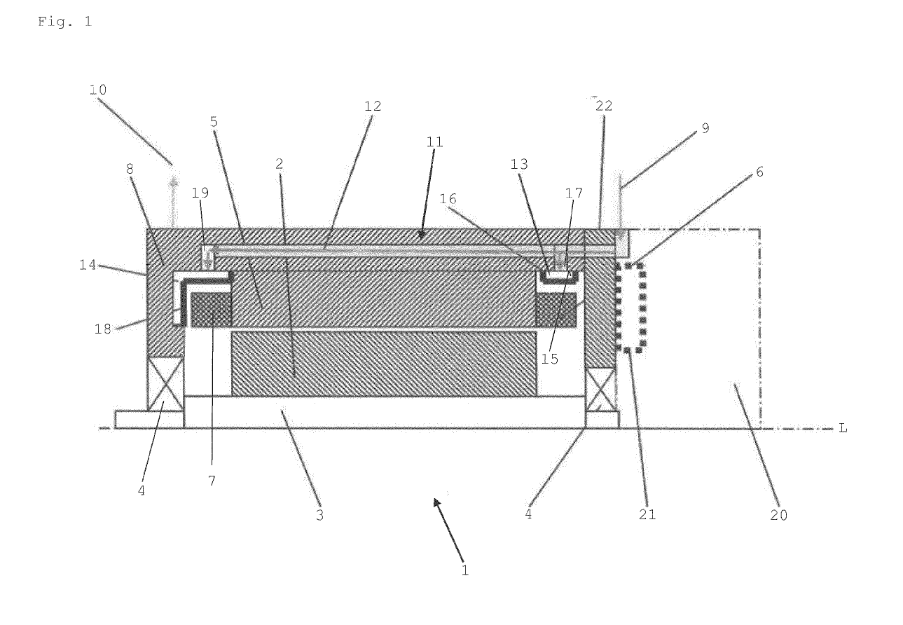

FIG. 1 shows the diagram of a half-section through an electric machine 1 with a rotor which comprises a rotor laminated core 2 and is mounted in a rotationally fixed fashion on a rotor shaft 3. The rotor shaft 3 is rotatably held within two bearings 4 which are arranged at axial ends of the electric machine 1. A stator with a stator laminated core 5 is arranged coaxially around the rotor or the rotor laminated core 2 thereof. Within the stator laminated core 5 there are coil windings, which form two stator winding heads 6 (illustrated on the right in FIG. 1) and 7 (illustrated on the left in FIG. 1) at ends of the stator laminated core 5 lying axially opposite one another. The stator winding heads 6 and 7 project beyond the rotor laminated core 2 in the axial direction.

Furthermore, the electric machine 1 comprises a die-cast housing 8, which is an outer housing and surrounds the stator laminated core 5 coaxially. The housing 8 has an inflow port 9 and an outflow port 10 for cooling fluid. The inflow port 9 and the outflow port 10 are connected to one another by means of a cooling duct 11. In this way, cooling fluid can enter via the inflow port 9, be conducted through the cooling duct 11, and be conducted away via the outflow port 10.

The cooling duct 11 comprises a drilled hole 12 which runs through the housing 8 in the axial direction L, a first radial cooling duct section 13 and a second radial cooling duct section 14. The first radial cooling duct section 13 is formed by an inner contour 15 of the housing 8 and a first installation part 16. For this purpose, the housing 8 has, in the region of the first radial cooling duct section 13, a duct-like recess or drilled hole 17 which is covered by the first installation part 16, so that the first radial cooling duct section 13 is produced, which cooling duct section 13 is impermeable to the cooling fluid and is produced in a positively locking fashion by a bonded connection between the installation part 16 and the housing 8. The first installation part 16 has a U profile in cross section and is arranged on the housing 8 in the region of the stator winding head 6 illustrated on the right in FIG. 1. In this way, cooling fluid which flows through the first radial cooling duct section 13 can cool the right-hand stator winding head 6.

In some embodiments, the second radial cooling duct section 14 is formed by means of the housing 8 and a second installation part in the form of a cooling duct cover 18. The second installation part 18 is attached in a materially joined fashion by means of a bonded connection to the housing 8 in the region of the stator winding head 7, which is illustrated on the left in FIG. 1. The axial drilled hole 12 which runs through the housing 8 is connected in the region of the left-hand stator winding head 7 to the radial drilled hole section 19 which in turn merges with the second cooling duct section 14, which is bounded by the second installation part 18 in a fluid-tight fashion and is connected to the outflow port 10 in a fluid-conducting fashion.

Furthermore, the electric machine 1 comprises an inverter 20 with an inverter cooling duct 21. In the exemplary embodiment shown, the inflow port 9 for the cooling fluid is arranged in the region of the inverter 20, wherein the axial drilled hole 12 which runs through the housing 8 continues in an end plate 22 of the electric machine 1 and is connected to the inflow port 9.

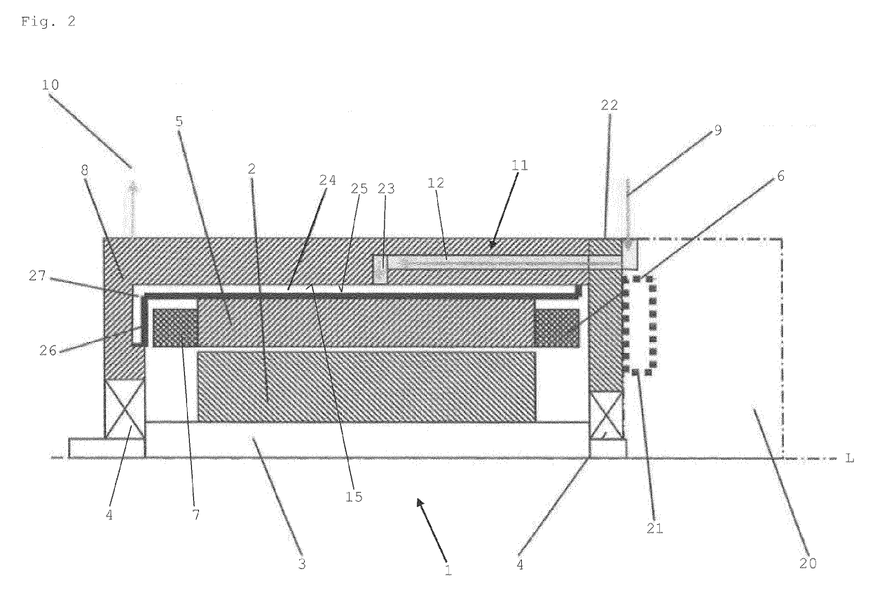

FIG. 2 shows a diagram of a half-section through a further electric machine 1 which differs from the electric machine 1 according to FIG. 1, in particular, in having a different embodiment of the cooling duct 11. The cooling duct 11 shown comprises a drilled hole 12 which runs in the axial direction L of the electric machine 1 within the housing 8 and continues in the direction of an inflow port 9 for coolant in an end plate 22 of the electric machine 1, wherein the inflow port 9 is arranged in an inverter 20 of the electric machine 1. The axial drilled hole 12 merges with a radial drilled hole 23 within the housing 8 in the direction of the axial end, illustrated on the left in FIG. 2, of the electric machine 1. The radial drilled hole 23 opens into an intermediate space 24 between an inner contour 15 of the housing 8 and an outer contour 25 of the stator laminated core 5, in the direction of the stator laminated core 5 of the electric machine 1.

A cooling duct cover 26 is arranged between the stator laminated core 5 and the housing 8, said cooling duct cover 26 forming an insertion part and running parallel over the entire length of the stator 5, with its stator winding heads 6 and 7 arranged at axial ends lying opposite one another.

The insertion part 26 and the housing 8 are connected to one another in a materially joined fashion in such way that a fluid-tight section 27 of the cooling duct 11 is produced, which section 27 can cool the entire outer region of the stator 5, in particular also the winding heads 6 and 7 thereof, and is connected in a fluid-conducting fashion to the outflow port 10.

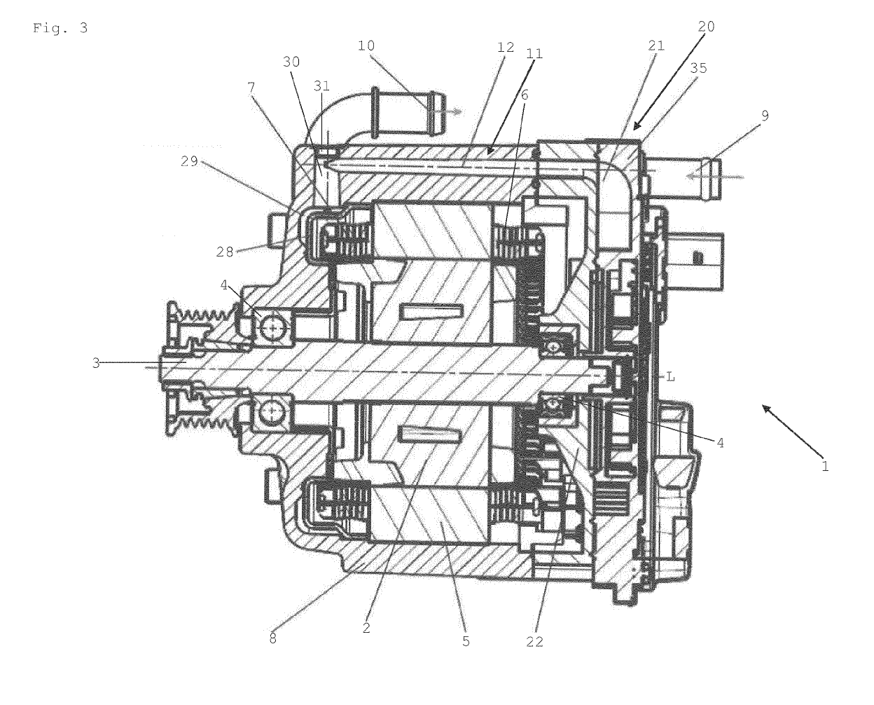

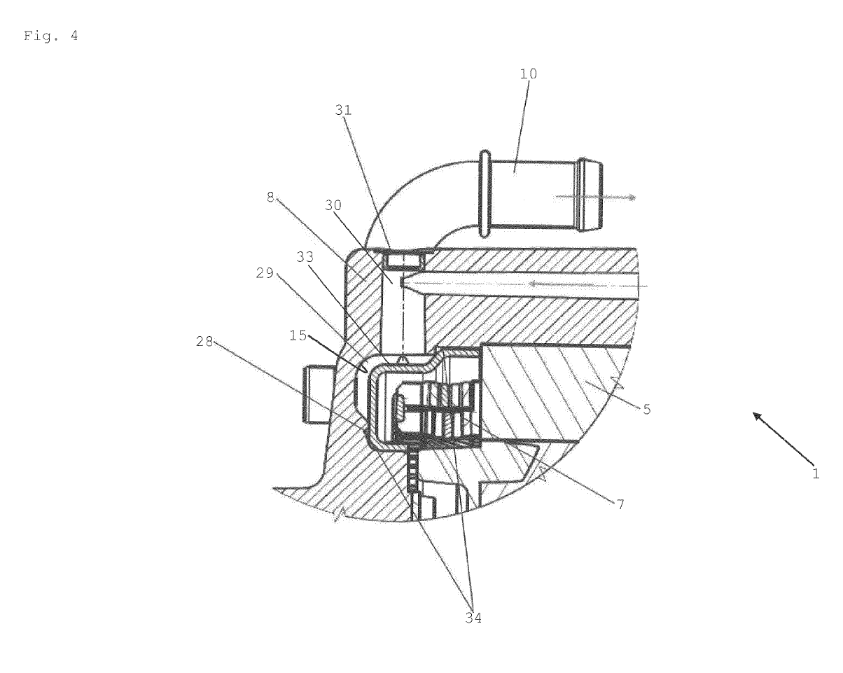

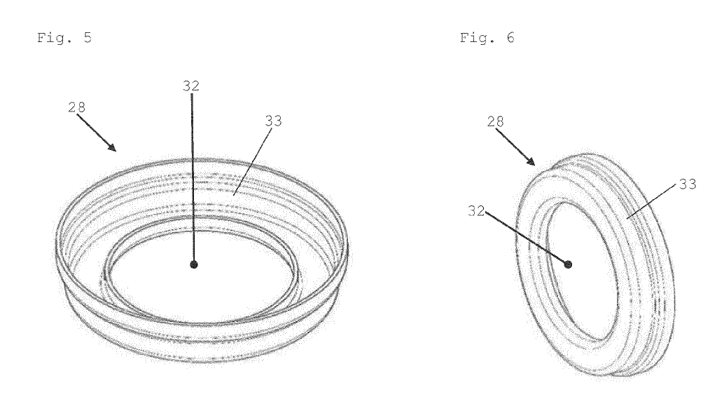

FIGS. 3 and 4 show a further electric machine 1 with a rotor which comprises a rotor laminated core 2 and is mounted in a rotationally fixed fashion on a rotor shaft 3. FIGS. 5 and 6 show an insertion part 28 which is suitable for the electric machine 1 according to FIG. 3 The rotor shaft 3 is rotatably held within two bearings 4 which are arranged at axial ends of the electric machine 1. A stator with a stator laminated core 5 is arranged coaxially around the rotor laminated core 2. Within the stator laminated core 5 there are coil windings, which form two stator winding heads 6 and 7 at ends of the stator laminated core 5 lying axially opposite one another. The stator winding heads 6 and 7 project beyond the rotor laminated core 2 in the axial direction.

Furthermore, the electric machine 1 has a die-cast housing 8 which is an outer housing and which coaxially surrounds the rotor with its rotor laminated core 2 and the stator with its stator laminated core 5 and its winding heads 6 and 7. The housing 8 has an inflow port 9 and an outflow port 10 for cooling fluid. The inflow port 9 and the outflow port 10 are connected to one another by means of a cooling duct 11. In this way, cooling fluid can enter via the inflow port 9, be conducted through the cooling duct 11, and be conducted away via the outflow port 10.

The cooling duct 11 comprises a drilled hole 12 which runs through the housing 8 in the axial direction and a radial cooling duct section 29 which is formed by an inner contour 15 (FIG. 4) of the housing 8 and an installation part in the form of a cooling duct cover 28. For this purpose, the housing 8 has, in the region of the radial cooling duct section 29, a radial drilled hole 30 which is closed off radially towards the outside by a closure cap 31 and is covered radially toward the inside by the installation part 28, so that the radial cooling duct section 29 is formed, which radial cooling duct section 29 is impermeable to the cooling fluid and is produced in a positively locking fashion by a bonded connection between the installation part 28 and the housing 8.

The deep-drawn installation part 28, e.g. made of aluminum, has an essentially U-shaped cross-sectional profile with a central opening 32, the one limb 33 of which is embodied in a stepped fashion, in order to be able to bear on the inner contour 15 of the housing 8 in certain areas, and to be able to be spaced apart in certain areas from the inner contour 15 in order to form the cooling duct section 29. The housing 8 forms two pockets or grooves which can be filled with adhesive in order to bring the installation part 28 subsequently into abutment with the housing 8 and to bond it thereto.

Coolant can, entering via the inlet port 9, be conducted along the axial drilled hole 12, the radial drilled hole 30 and the cooling duct section 29 and exit via the outlet port 10. In this way, cooling fluid which flows through the cooling duct section 29, can, in particular, cool the stator winding head 7 illustrated on the left in FIG. 3.

Furthermore, the electric machine 1 comprises an inverter 20 with an inverter housing 35 and an inverter cooling duct 21. In the exemplary embodiment shown, the inflow port 9 for the cooling fluid is arranged in the region of the inverter 20, wherein the axial drilled hole 12 which runs through the housing 8 continues in an end plate 22 of the electric machine 1 and is connected to the inflow port 9.

What is claimed is:

1. An installation part for a housing of an electric machine, the installation part comprising:
a contour configured to mount within the housing; and
a feature defining a section of a cooling duct when the installation part is joined together with the housing.

2. The installation part as claimed in claim 1, wherein the section of the cooling duct defined by the installation part is located in a region of a winding head of the electric machine.

3. The installation part as claimed in claim 1, wherein the installation part comprises a deep-drawn, sheet-metal part.

4. A housing for an electric machine, the housing comprising:
a mount for components of the electric machines; and
a feature defining a section of a cooling duct together with an installation part mounted within the housing.

5. The housing as claimed in claim 4, further comprising a depression or drilled hole in the region of the section of the cooling duct.

6. The housing as claimed in claim 4, wherein a thickness of the housing is greater in the region of the section of the cooling duct than a thickness of the installation part.

7. The housing as claimed in claim 4, wherein an axial extent of the installation part is less than 30% of the maximum axial extent of the housing.

8. The housing as claimed in claim 4, wherein the installation part is connected in a materially joined fashion to the housing.

9. The housing as claimed in claim 4, wherein the installation part is connected to the housing in a materially joined fashion by means of a bonded connection, and
pockets or grooves for adhesive of the bonded connection are formed between the installation part and the housing.

10. An electric machine comprising:
a housing comprising a mount for components of the electric machines and a feature defining a section of a cooling duct together with an installation part mounted within the housing; and
an installation part comprising a contour configured to mount within the housing and a feature defining the section of the cooling duct when the installation part is joined together with the housing.

11. A method for producing an electric machine, the method comprising:
attaching an installation part comprising a contour configured to mount within a housing and a feature defining the section of the cooling duct when the installation part is joined together with the housing to the housing;
the housing comprising a mount for components of the electric machines and a feature defining the section of the cooling duct together with the installation part.
